(19) United States
(12) Patent Application Publication
(10) Pub. No.: US 2021/0191935 A1
(43) Pub. Date: Jun. 24, 2021

(54) SYSTEM FOR FAST SEARCHING OF TIME SERIES DATA USING THUMBNAILS

(71) Applicants: AJIT BHAVE, PALO ALTO, CA (US); ARUN RAMACHANDRAN, PALO ALTO, CA (US); BOLT ANALYTICS CORPORATION, MOUNTAIN VIEW, CA (US)

(72) Inventors: AJIT BHAVE, PALO ALTO, CA (US); ARUN RAMACHANDRAN, CUPERTINO, CA (US)

(73) Assignee: BOLT ANALYTICS CORPORATION, MOUNTAIN VIEW, CA (US)

(21) Appl. No.: 16/725,089

(22) Filed: Dec. 23, 2019

(51) Int. Cl. G06F 16/2458; G06F 11/30; G06F 16/2453; G06F 16/53; G06N 5/04

(52) U.S. Cl. CPC G06F 16/2474; G06F 11/3075; G06N 5/04; G06F 16/53; G06F 16/24539

(57) ABSTRACT

The system and apparatus of the invention seek to represent time series data as a series of time series thumbnails models and attempts to answer whatever queries which come in from the thumbnails. This way some queries can be answered quickly from the time series thumbnails models, while the remaining queries that cannot be answered from the thumbnails models, need access to the entire data collection for analysis. The time series thumbnail modeling system acts as a sort of cache system that sits in front of the query system acting to short circuit queries that come in by attempting to answer them from the collection of thumbnails models rather than the whole data collection. Queries that cannot be answered from the thumbnails models are then routed to the query processor for the entire data set.

### BACKGROUND OF THE INVENTION

In the management of IT systems and other systems where large amounts of performance data is generated, there is a need to be able to gather, organize and store large amounts of performance data and rapidly search it to evaluate management issues.

Systems for searching of time series data have heretofore been limited by the need to collect the time series data and organize it into some form of database or flat file before accessing the time series data itself. Then, after assembling all the time series data, it can be accessed with some query and the question answered. The query can have a filter or filters, limitations on time, etc. to limit the amount of data that is collected for the query.

Many situations that need monitoring can be represented by time series data. This data is gathered by a series of sensors spread around the system. Most of the time the sensors gather only data that is within the range of normalcy for that sensor. However, when something goes wrong, the sensor will report a series of readings that are out of the norm for that sensor. It is that data which is of interest to managers of the system.

For example, server virtualization systems have many virtual servers running simultaneously. Management of these virtual servers is challenging since tools to gather, organize, store and analyze data about them are not well adapted to the task. One prior art method for remote monitoring of servers by time series data generated by sensors, be they virtual servers or otherwise, is to establish a virtual private network between the remote machine and the server to be monitored. The remote machine to be used for monitoring can then connect to the monitored server and observe performance data gathered by the probes. The advantage to this method is that no change to the monitored server hardware or software is necessary. The disadvantage of this method is the need for a reliable high bandwidth connection over which the virtual private network sends its data. If the monitored server runs software that generates rich graphics, the bandwidth requirements go up. This can be a problem and expensive especially where the monitored server is overseas in a data center in, for example, India or China, and the monitoring computer is in the U.S. or elsewhere far away from the server being monitored.

Another method of monitoring a remote server's performance is to put an agent program on that gathers performance data as time series and forwards the gathered data to the remote monitoring server. This method also suffers from the need for a high bandwidth data link between the monitored and monitoring servers. This high bandwidth requirement means that the number of remote servers that can be supported and monitored is a smaller number. Scalability is also an issue.

Other non IT systems generate large amount of time series data that needs to be gathered, organized, stored and searched in order to evaluate various issues. For example, a bridge may have thousands of stress and strain sensors attached to it which are generating stress and strain readings constantly. Evaluation of these readings by engineers is important to managing safety issues and in designing new bridges or retrofitting existing bridges.

Once time series performance data has been gathered, if there is a huge volume of it, analyzing it for patterns is a problem. Prior art systems such as performance tools and event log tools use relational databases (tables to store data that is matched by common characteristics found in the dataset) to store the gathered data. These are data warehousing techniques. SQL queries are used to search the tables of time-series performance data in the relational database.

In recent trends, NoSQL stores are more often used to store time series data than relational databases are used. Rarely are people using relational databases. Couchbase servers provide the scalability of NoSQL with the power of SQL. NoSQL was expressly designed for the requirements of modern web, mobile, and IoT applications. https://info.couchbase.com/nosql_database.html?utm_source=google&utm_medium=search&utm_campaign=Nonbrand+-+US+-+Desktop+-+GGL+-+Phrase&utm_keyword=nosql&kpid=go_cmp-6818000338_adg-85310837011_ad-389364052297_kwd-444150946785_dev-c_ext-_prd-&gclid=CjOKCQiAxfzvBRCZARIsAGA7YMziHwdvjij46TL80L7fkR1m2rZ5c127nQ X3fP-BqjpabeyMkP3sGCgaAh2UEALw_wcB

Storage mechanisms that use SQL on non-SQL will require large amounts of storage when the number of time series is high and retention times increase. The problems compound as the amount of performance data becomes large. This can happen when, for example, receiving performance data every minute from a high number of sensors or from a large number of agents monitoring different performance characteristics of numerous monitored servers. The dataset can also become very large when, for example, there is a need to store several years of data. Large amounts of data require expensive, complex, powerful commercial databases such as Oracle.

There is at least one prior art method for doing analysis of performance metric data that does not use databases. It is popularized by the technology called Hadoop. In this prior art method, the data is stored in file systems and manipulated. The primary goal of Hadoop based algorithms is to partition the data set so that the data values can be processed independent of each other potentially on different machines thereby bring scalability to the approach. Hadoop technique references are ambiguous about the actual processes that are used to process the data. NoSQL databases are another prior art option.

So the problem of efficiently monitoring systems which generate large amounts of time series data is a problem of tackling large amounts of data. While the prior art now includes systems for generating Unicode entries for each time series number and storing the Unicode in a special file system, it still requires access to the full data collection. This file system can be queried with queries which have filters and regular expressions, but it still involves taking on the whole file system. Therefore, a need has arisen for an apparatus and method to represent the data in some compact fashion such as a model and query the model, and if an answer can had from the model, good, and, if not, resort to the entire data system can proceed.

### BRIEF DESCRIPTION OF THE DRAWINGS

FIG. 1 is a block diagram of a preferred embodiment of the thumbnail model maker.

FIG. 2 is a block diagram of the apparatus for resolving queries using thumbnails.

FIG. 3 is a block diagram of one embodiment for the inference engine.

FIG. 4 shows the process of operation of the inference engine.

FIG. 5 is a diagram of the process of carried out in the thumbnail cache 8 for answering queries about what a data point from a particular time stamp is.

FIG. 6 is a diagram of the process of carried out in the thumbnail cache 8 of receiving models and storing them in the appropriate one of memory segments s1, s2 or s3.

FIG. 7 is a diagram of the process of carried out in the thumbnail cache 8 of comparing the number of anomalies in the anomaly portion 40 of s1 to a constant indicative of the time that is time to gather new base data points on a data stream in data point accumulator 12 and release them to one of the model makers for retraining.

FIG. 8 is a diagram of the process of carried out in the thumbnail cache 8 of receiving a query about the data points is a data stream and answering it.

### SUMMARY OF THE INVENTION

The system and apparatus of the invention seek to represent time series data as a series of time series thumbnail models and attempts to answer whatever queries which come in from the thumbnails. This way some queries can be answered quickly from the time series thumbnails models, while the remaining queries that cannot be answered from the thumbnails models, need access to the entire data collection for analysis.

The time series thumbnail modeling system acts as a sort of cache system that sits in front of the query system acting to short circuit queries that come in by attempting to answer them from the collection of thumbnails models rather than the whole data collection. Queries that cannot be answered from the thumbnails models are then routed to the query processor for the entire data set. Throughout this description, streams of data points sampled over time by probes or otherwise and designated s1, s2 and s3 are variously referred to as time streams or data streams, but they refer to the same thing.

The thumbnails models can be made by any modeling process. SARIMA is one process that works. Many models and modeling processes are in existence and more are being developed all the time. A neural network is another process that will work. The thumbnail model generation process can be used by any of them.

In the preferred embodiment, the system comprises an ingest layer that receives multiple stream of time stream data and has two outputs. One output is connected to an inference engine that draws an inference whether a data point falls within the normal expected range or is an outlier or anomaly and needs to be reported to an anomaly memory coupled so that the data point which generated the anomaly can be found. The inference engine has an input to the thumbnail modeling process that contains the time series data point of the time series it is receiving at the moment. This input acts as a query. The thumbnail model checks the model it stores for that time series, and returns with an expected value for that data point. The inference engine uses that input from the thumbnail model to draw the inference. The inference engine then compares the actual data point to the expected data point and draws an inference if the actual data point is an anomaly. If it is, the inference engine sends the data point along with its time of collection to the thumbnail model for storage in an anomaly memory.

One way of obtaining the expected value of the data point is to use a polynomial process generated by the SARIMA process. This polynomial can be used to predict the value of a data point. The whole purpose of the inference engine is to report outliers or anomalies in the thumbnail model. It reports one or more anomalies as a point in a metadata memory. The point in the metadata memory can be associated with the data point corresponding in the thumbnail model by the time of collection of the corresponding data point. The actual data points of the expected behavior bases on the polynomial or neural network are not stored in the thumbnail model. Only a model of the data points in the form of a polynomial or neural network or any other model is stored along with the time of collection of the data points.

If the metadata reports begin to build up over time, it is time to generate a new thumbnail. A comparator or software process in the thumbnail generator (or elsewhere) compares the number of anomalies to a threshold and sets a flag, typically in the ingest layer, when that threshold is exceeded. The ingest layer, which is like a reverse multiplexer, then, for that time series, directs the input for the time series to a data point accumulator for re-accumulation of data points for the time of collection of data points. This accumulator has enough addresses to store the minimum required data points for a model to train.

The thumbnail model memory has a plurality of inputs, each coupled to an output from a different model generator. The timeshare model generator picks one such model generator automatically based on the timeshare data characteristics. One such model maker is a SARIMA engine. The SARIMA engine has an input from the sample memory. The sample memory has one memory slot per time slot in whatever the time for sampling of one time stream data source is. For example, if the sample period is one day, and a sample is taken every minute, the sample memory has 1440 memory slots, each to hold one sample. Obviously, the sample memory should be a structure that has one address per data value for whatever the sample period is.

These 1440 data points are fed to the model generation process. 1440 data points is used as the example, but, in reality, it can be any number of data points needed to train the prior art model generation process. The prior art model generation process receives these data points and does its thing to generate a model. Any model generation process will work including model generation process that are not currently known but which can generate a nominal data point from the time of collection and a region of confidence indication.

In the case of prior art SARIMA model generator, the 1440 data points are turned into a polynomial which generates the expected value for every data point that comes in for future data collections. It also creates from these data points an expected high and an expected low for every data point and outputs those curves to the model generation process. The output of the SARIMA modeling process is three equation defining the curve of expected performance of the data point and one curve representing the highest expected data point value and one equation which represents the curve of the lowest expected value for the data point. In the case of neural network, the output is a list of nodes, the interconnection of the nodes and the weights that would cause them to fire for the representative value and the highest and lowest values of the data point.

The thumbnail model also has a query input. A query typically take the form of: “for time series s1, give me all the data points from time t1 to time t2 for filter value x1.” The timeshare model responds to this query by generating all data points between times t1 and t2 in a memory and checking for any anomalies for any of the data points. A results memory with timeslots for each data point then is filled with the data points or the anomalies if there is an anomaly for a data point. The resulting results memory is then provided to the output of the thumbnail modeler. The thumbnail model can also do Root-Cause analysis because the cause is very often represented in one of the time series from the machine or system being monitored.

In the current description and claims, for every time series of data points, there is one model generated in the thumbnail cache. However, in some situation where there is some relationship between multiple series, the system could build a single model which captures all the related series e.g. the count of errors produced by a system grouped by error code value. Lets say the system has 5 possible error codes. Then there are 5 series. A single model could be built and stored in thumbnail cache. A single model can return expected values of all 5 series at once.

This result from using thumbnail modeling of the times series data is very fast and that is the advantage of the thumbnail models. If the thumbnail models cannot answer the question, the query is passed along to another system that keeps all the data for answering.

The thumbnail model has hooks in it so that it can be easily adapted for use when other modeling processes are developed.

### DETAILED DESCRIPTION OF THE VARIOUS EMBODIMENTS

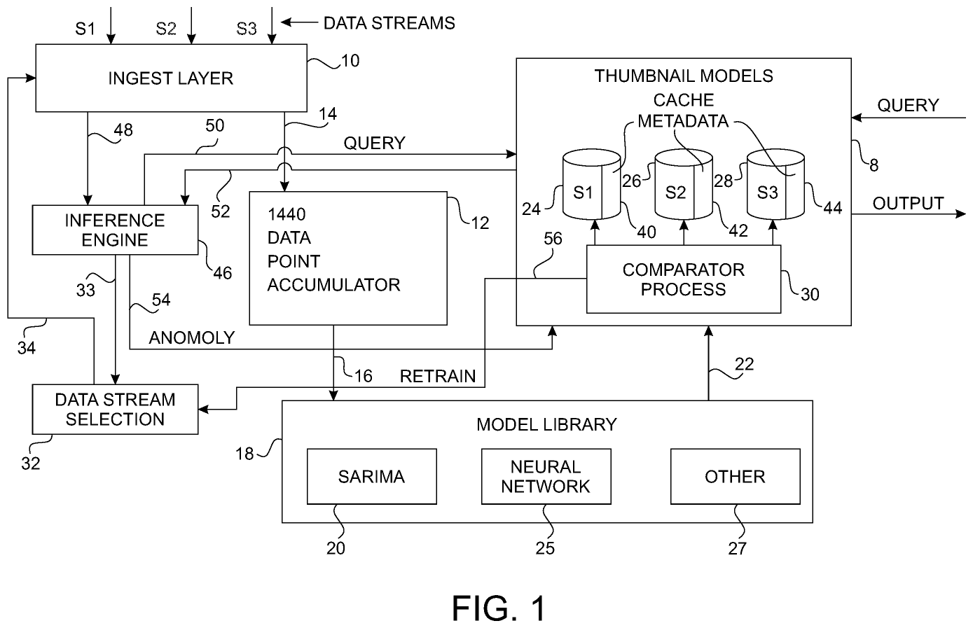

Referring to FIG. 1, there is shown an overall block diagram of a system that can embody the teachings of the preferred embodiment of the invention. There is an ingest layer 10 that serves to receive one or more time series of data s1, s2 and s3, for example. The ingest layer functions as a multiplexer, and it may be a multiplexer along with associated hardware to handle the flag from the comparator process 30 in the thumbnail models storage 8. At time to, there is no model for any time series. So the multiplexer in the ingest layer 10 function to select one time series, say s1, and starting at the time of collection of the first data point, steers all the data points over line 14 to a data point accumulator 12. This is called a 1440 data point accumulator 12 for the typical collection of data points from time series that collects for 24 hours at one sample point per minute, but it must have the minimum required data points to train the model. The data point accumulator has enough memory to store all the data points from any of the sample streams s1, s2 and s3. There may be as few as 100.

The data point accumulator 12 has one memory slot or memory address coupled to a memory location for every data point in the time series. The data point accumulator 12 serves to store one data point in the series in the corresponding memory slot corresponding to the time slot of collection.

After accumulating a full complement of data points from one time series, the data point accumulator releases all the sample data over line 16 to the model library 18. The model library 18 takes the sample data points in, for example a comma separated list format, and the time stream designator, in this case s1, and generates a model of behavior of the data and a confidence region of the highest a data point could go and the lowest the data point could go at any particular time.

In the case of SARIMA model creator 20, a polynomial is created which represents the data point at any particular time, as well as a confidence level bounded by two curves. The curves represent a high level curve and a low level curve and they respectively representing the highest and lowest the data point could assume at any particular time. The three formulas are the output on line 22 to the thumbnail storage facility 8 and stored in memory 24 in the case of time stream s1. In case the data stream is s2, the model for s2 is stored in memory 26. In the case of s3, the model is stored in memory 28. The memories are shown as bulk storage like a disk drive, but the memories can be any sort of memory such as RAM.

A data stream selection process 32 generates signals on line 34 which are coupled to ingest layer and control which data stream said data stream selector selects for output to the data point accumulator 12 and which data stream is selected for output to said inference engine. In one embodiment, said ingest layer is comprised of a FIFO memory for storing individual data points of each data stream in a FIFO fashion (one or more FIFO memories may be needed, one for each data stream). The switching signals on line 34 control which FIFO memory is being read and output 48 to the inference engine. A signal on line 33 from the inference engine 46 to the data stream selection means 32 indicates when the inference engine in done processing the data point it is working on and is ready for the next data point. The data point selection means 32 may decide which FIFO memory to access based upon the fullness of the FIFO memory for any particular data stream. The next in line data point from the selected data stream will then be put on output 48 along with it data stream designator.

When a new model has to be created or retrained for a particular data stream in model library 18, the switching signals on line 34 cause a full set of data points from FIFO memory for the designated data stream to be sent to the data point accumulator 12, starting with the first data point captured in said first time slot of said designated data stream. The full set of data points is released to the model library 18 on line 16 along with the data stream designator when collection is finished and are then used to train or retrain the model such as prior art SARIMA model 20. The model trained is then output to the thumbnail model cache 8 on line 22 along with a data stream designator.

In the case of a prior art neural network 25, there is output on line 22 three models of a neural network to generate: the data point for the representative data point, and the highest value the data point could assume and lowest value the data point could assume. The neural network must be trained. It does this with the sample data from the data point accumulator 12. The comma-separated values are input to the neural network multiple times while the neural network is training. Each time the weights of the various nodes are adjusted until the output represents the projected value of the data point. It does this training process for each point in the data point accumulator 12. The process is repeated for the highest value the data point could assume and the lowest value the data point could assume.

The three neural nets are stored in memory 24. Each neural net comprises the number of nodes in the network, the interconnections of these nodes and the weights that cause each node to fire.

In the case of some other network model such as network model 27, the model output on line 22 takes some other form and is stored in memory 24.

Memory 26 and 28 also store the model generated by the model library 18 for the data stored by data point accumulator 12 when the ingest layer is in a position to take the time series s2 and s3, respectively.

There is an inference engine 46 which receives an input 48 from the ingest layer after a model is generated in model library 18 and passed on line 22 to the thumbnail model storage 8 and stored in the appropriate model storage. The inference engine serves to monitor all the time streams and generate anomalies for every point if the data point is outside the bounds of confidence suggested by the three curves generated by the SARIMA model creator (or outside bounds of confidence generated by any of the other model generators). In the preferred embodiment, the inference engine has a query line 50 that goes to the thumbnail model storage 8. There is an identification of the time stream and the time of collection of a data point on the line 50. The thumbnail model storage takes the identification of the time stream and the time of collection of the data point and plugs these numbers into the model for that time stream. For example, the model of the time stream s1 in memory 24 is downloaded that the time of collection is loaded as the query. The model calculates the value for the data point for that time of collection, and outputs the value on an output line 52 that goes back to the inference engine. The inference engine the compares to real value of the data point from the time stream to the projected value from the model's calculation, and if the real data point has a value outside the bounds of confidence, the inference engines tags it as anomaly and outputs the value of the data point, the time stream from which it originated and the time of collection on anomaly output 54. The thumbnail model storage 8 take this anomaly report and stores the value of the data point in the memory such as 24 in the section for anomaly reports 40 at address for the time of collection as reported on the anomaly line 54.

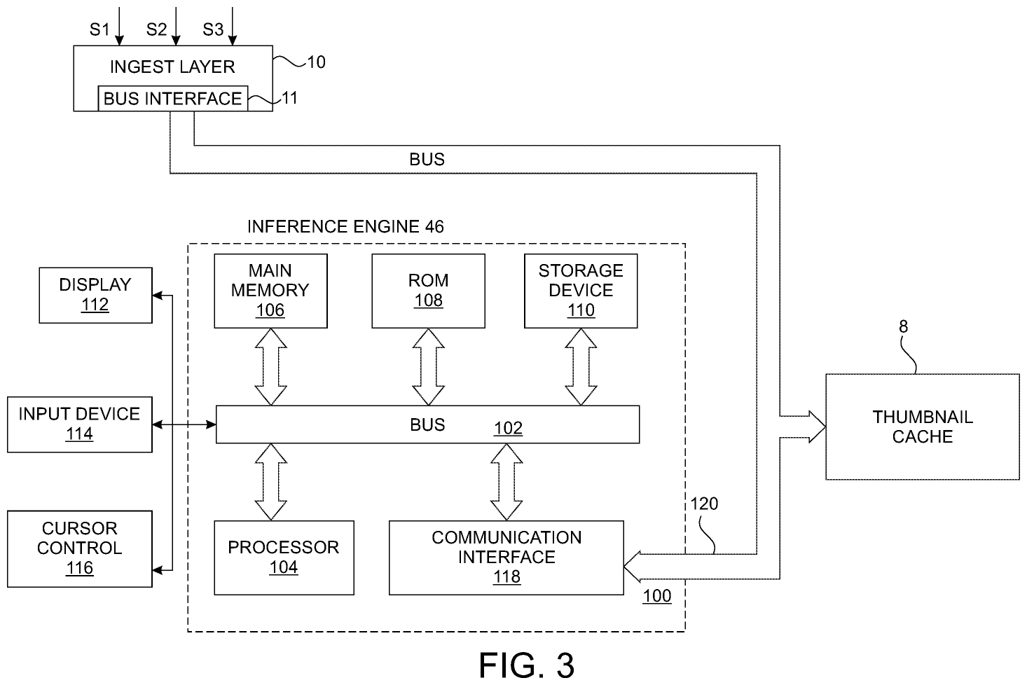

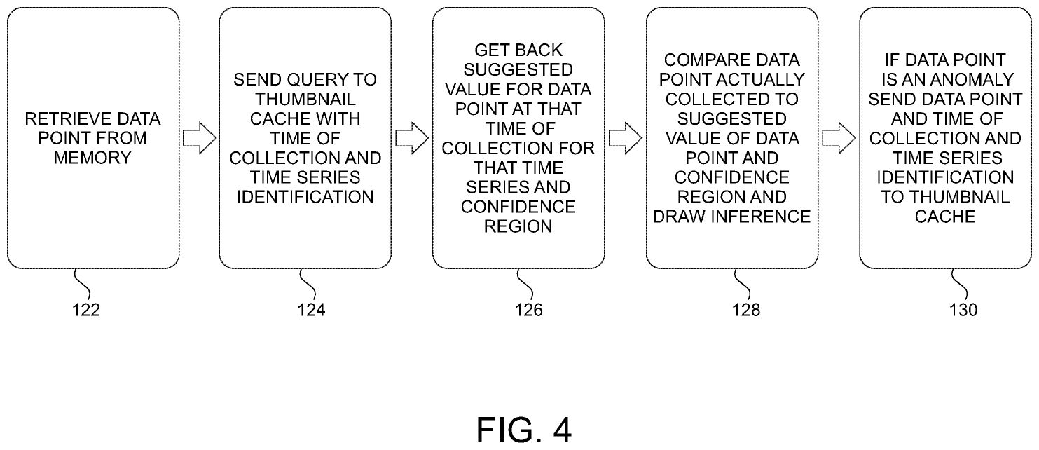

The inference engine can be either hardware or the process can be carried out by a software process. If it is a software process, multiple instances of the inference engine can run simultaneously, one for each data point on each time series line as illustrated in FIG. 3 and FIG. 4. That way if the data points are arriving simultaneously on different time series, one inference engine process is allocated to each data point. Each inference engine operates in the manner just described.

If the inference engine is hardware, there is a queue for the data points that includes the time series that the data point originated from, the time of collection and the value of the data point. The inference engine processes these data points one at a time in the manner described above.

As mentioned above, there is a comparator process 30 which monitors the metadata stored in sections 40, 42 and 44 of the three memories 24, 26 and 28. If the amount of data points in the anomaly section exceeds some predetermined (which can be user determined) threshold, the comparator process 30 sets a signal on line 56 to the data stream selection 32 indicating the data stream that needs retraining. This flag indicates to the data stream selection means 32 that a new model is needed for whatever data stream is indicated. The data stream selection means 32 then generates a signal on line 34 that causes the ingest layer 10 to select the data stream indicated by the signal on line 56 for output to the data point accumulator 12 at the point in time when the data stream starts anew. The data point accumulator 12 then starts collecting data points again for a new training cycle of the selected model generator 20, 25 or 27.

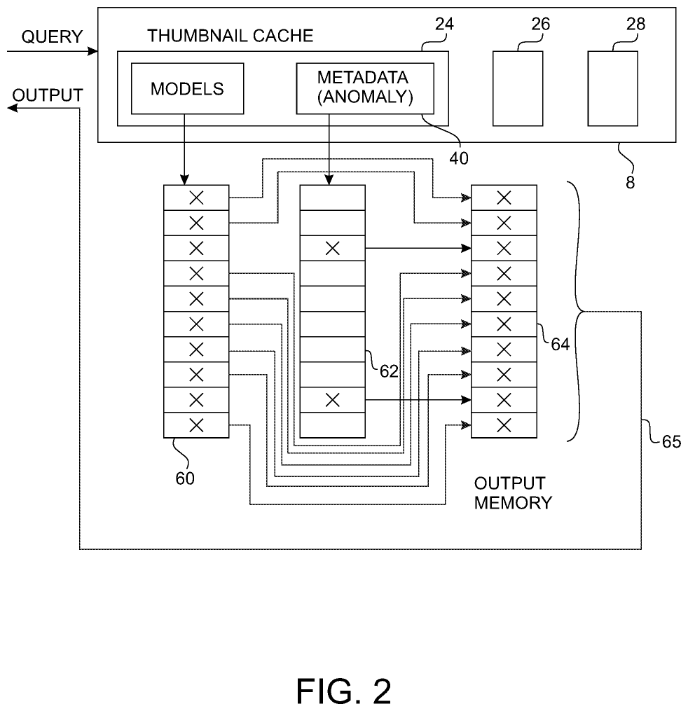

Referring the FIG. 2, a block diagram of the query process apparatus is shown. The thumbnail cache 8 has a section 60 of memory 24 for the calculated data points and a section of memory 62 for the anomaly values. Query typically have the form of: “for time series s1, give me all the data points from time t1 to time t2 for filter value x1.” The timeshare cache responds to this query by generating all data points between times t1 and t2 in a memory 60 and checking for any anomalies for any of the data points in memory 62. A output memory 64 with timeslots for each data point then is filled with the data points or the anomalies if there is an anomaly for a data point. The resulting output memory 64 is then provided to the output of the thumbnail cache. This result from using thumbnail modeling of the times series data is very fast and that is the advantage of the thumbnail models. If the thumbnail models cannot answer the question, the query is passed along to another system that keeps all the data for answering.

Referring to FIG. 3, there is shown a block diagram of one embodiment for an inference engine. FIG. 3 shows an embodiment of a microprocessor running multiple inference engine processes simultaneously to take care of all the data points arriving simultaneously on all the time streams s1, s2 and s3. FIG. 3 is a block diagram of a typical server on which the processes described herein for multiple instances of an inference engine can run. Computer system 100 includes a bus 102 or other communication mechanism for communicating information, and a processor 104 coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 further usually includes a read only memory (ROM) 108 or other static storage device coupled to bus 102 for storing static information and instructions for processor 104 such as an operating system. A storage device 110, such as a magnetic disk or optical disk, is provided and coupled to bus 102 for storing information and instructions. Usually the data points from time series lines s1, s2 and s3 is stored in directory structures on storage device 110 and processed by the processor 104.

Computer system 100 may be coupled via bus 102 to a display 112, such as a cathode ray tube (CRT) or flat screen, for displaying information to a computer user who is monitoring performance of the inference engine. An input device 114, including alphanumeric and other keys, is coupled to bus 102 for communicating information and command selections to processor 104. Another type of user input device is cursor control 116, such as a mouse, a trackball, a touchpad or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane.

The processes described herein are used to develop inferences for data points and uses computer system 100 as its hardware platform, but other computer configurations may also be used such as distributed processing. According to one embodiment, the process to receive and perform inferences for data points is provided by computer system 100 in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. One or more processors in a multi-processing arrangement may also be employed to execute the sequences of instructions contained in main memory 106. In alternative embodiments, hard-wired circuitry may be used in place of or in combination with software instructions to implement the teachings of the invention. Thus, embodiments of the invention are not limited to any specific combination of hardware circuitry and software.

The term “computer-readable medium” as used herein refers to any medium that participates in providing instructions to processor 104 for execution. Such a medium may take many forms, including but not limited to, non-volatile media, volatile media, and transmission media. Non-volatile media include, for example, optical or magnetic disks, such as storage device 110.

Volatile media include dynamic memory, such as main memory 106. Transmission media include coaxial cables, copper wire and fiber optics, including the wires that comprise bus 102 and bus 120. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in supplying one or more sequences of one or more instructions to processor 104 for execution. For example, the instructions may initially be borne on a magnetic disk of a remote computer. The remote computer can load the instructions into its dynamic memory and send the instructions over a telephone line using a modem. A modem local to computer system 100 can receive the data on a telephone line or broadband link and use an infrared transmitter to convert the data to an infrared signal. An infrared detector coupled to bus 102 can receive the data carried in the infrared signal and place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102 and coupled to bus 120. Communication interface 118 provides a two-way data communication coupling to a bus 120: for receiving data points from the time streams; for sending queries to the thumbnail cache for each data point; for receiving the suggested value for each data point and for outputting the data points to the thumbnail cache that are deemed anomalies. For example, communication interface 118 may be a I/O device to: receive data points from bus 120 and place them on bus 102 for transfer to storage device 110; to communicate queries for a particular data point and a particular time slot to the thumbnail cache; to receive the calculated value for the data point from the thumbnail cache; and send the data points and time slots of collection for data points recognized as anomalies to the thumbnail cache 8. In any such implementation, communication interface 118 sends and receives electrical, electromagnetic or optical signals that carry digital data streams representing various types of information.

The ingest layer 10 serves to interface all time series data points of all time series onto the bus 120 addressed to communications interface 118. In one embodiment the bus 120 is a multiplexed bus with one time slot for every data point. The bus interface 11 waits for the time slot for each data point to arrive the puts the data point on the bus and writes the address of the communication interface 118 in the address lines of the bus. The bus 120 has both data and address lines.

Referring to FIG. 4, there is shown the process of operation of one instance of the inference engine. Each inference engine instance operates in the same way. Step 122 involves the inference engine instance making a request for the next data point in memory for the time series the instance is assigned to. That involves the processor 104 addressing whatever memory its data points are in, usually the storage device 110, checking it counter (kept in software) for the next time slot of collection, are making a request. The data point arrives on the bus 102 and process step swings into action to generate a query to the thumbnail cache for the suggested value and the region of confidence. The query is generated along with the time of collection of the data point and the identification of the time series. The processor the addresses the thumbnail cache 8 and the puts the time of collection and the time series identifier on bus 104/120 and then waits.

The thumbnail cache then takes the time of collection and the time series identifier and accesses the appropriate memory storing the model for that time series. If it a polynomial for the model, the processor or whatever is used to do the calculation plugs in the time of collection and gets back and suggested value for the data point. The same process is used for the two curves setting the boundaries to get the high point and low point of values for the data point.

The processor or other hardware of the thumbnail cache the take these three data points, puts them on the bus 120 addressed to the microprocessor 104 and sends the back to the inference engine 46.

Processor 104 gets back the suggested value of the data point along with the high number and the low number for the data point in step 126. In step 128, the processor 104 compares the actual data point received from the time series and the high number and low number and draws an inference.

If the actual data point received is outside the bounds of the region of confidence, processor 104 decides it is an anomaly in step 130. In such a case, the processor sends the actual data point received, the time of collection of the data point and the identifier of the time series to the thumbnail cache for storage. The thumbnail cache then stores the data point in the appropriate time slot of the appropriate memory for the time series model. Processing then moves on to the next data point.

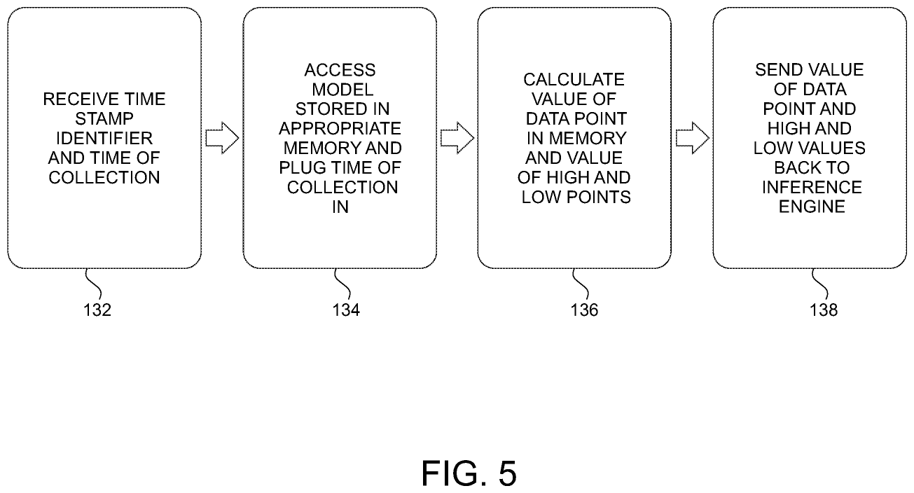

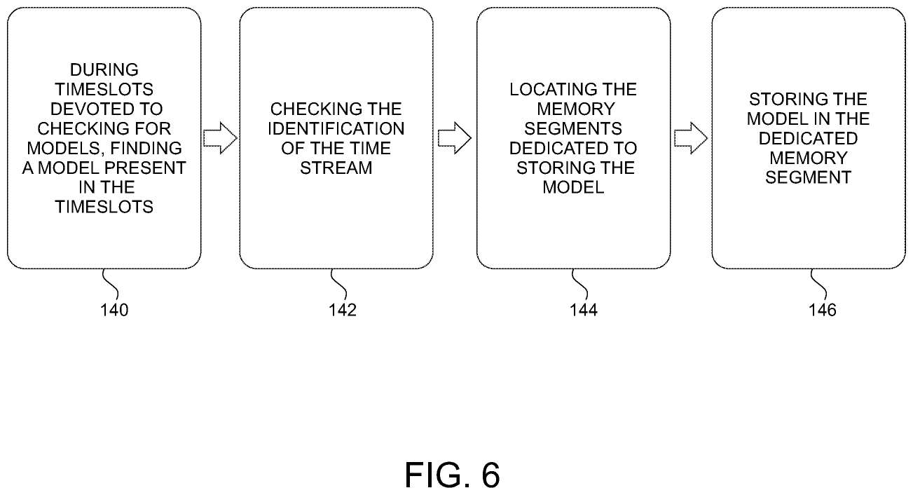

FIG. 5 is a diagram of the process of carried out in the thumbnail cache 8 for answering queries about what a data point from a particular time stamp is. For this embodiment and for all the embodiments of FIGS. 6, 7 and 8, it is assumed that the hardware of the thumbnail cache is a microprocessor and these routines are running in the software of the microprocessor. In fact, the thumbnail cache can be running on the same microprocessor as the inference engine, and that will be assumed in this embodiment. In other embodiments, the hardware of the thumbnail cache is dedicated glue logic including memories 24, 26 and 28, a comparator 30, logic to receive data points and time slip identities and access the appropriate model stored in memory and calculate the appropriate data point and the high and low values of the data point and return them to the inference engine 46. Also included is logic to receive a query, parse it to determine the time slip and the start and stop times of the query and calculate the appropriate data points and store these data points in an output memory and compare the anomaly data point values in the time slots that have anomaly values stored in the anomaly memories 40, 42 and 44, and substitute the anomalies in the output memory.

In FIG. 5, step 132 receives the value of the time stamp identifier form the inference engine as well as the time of collection of the data point that is the query. Microprocessor 104 determines the memory segment that the model for the time series and accesses it from storage device 110, and plugs in the time of collection to the polynomial (or enters it in the neural network) in step 134. The microprocessor 104 then calculates the value of the data point using the parameters of the polynomial and calculates the high and low values from the information stored in the memory segment (or calculates these values using the neural network or other model) in step 136. Finally, in step 138, the values of the three data points is sent back to the inference engine 46, which, in the embodiment shown, is a transfer to memory 106 along with an notification that there is data waiting to be processed in the memory.

FIG. 6 is a diagram of the process of carried out in the thumbnail cache 8 of receiving models and storing them in the appropriate one of memory segments s1, s2 or s3. Step 140 involves checking the timeslots on the bus that are dedicated to sending a model from the model library 18 to the thumbnail cache. The bus 120 is a time division multiplexed bus, and certain timeslots are dedicated to sending the model data for storage in memory in the thumbnail cache. Lets say that timeslot 100 to timeslot 110 are dedicated to sending the model data. When timeslot 100 rolls around, a flag on the bus (one the data bits) is set indicating new model data is available. The microprocessor 104 sees the flag and accesses timeslot 100 to 110 the gathers model data. If all the model data does not fit in timeslots 100 through 110, the microprocessor waits till timeslot 100 comes around again and resumes gathering data about the model. In step 142, the microprocessor 104 checks the data on the bus to determine the time series identifier to determine if the model data is for stream s1, s2 or s3. In step 144, the microprocessor locates the memory segment devoted to storing the model for the given stream. In step 146, the microprocessor 104 stores the model data gathered from the bus timeslots in the memory segment devoted to storing models for that data stream.

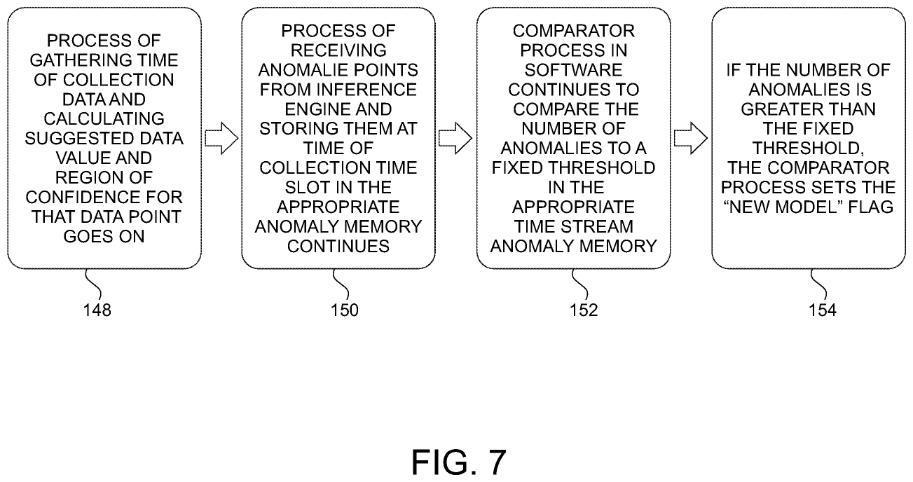

FIG. 7 is a diagram of the process of carried out in the thumbnail cache 8 of comparing the number of anomalies in the anomaly portion 40 of s1 to a constant indicative of the time that is time to gather new base data points on a data stream in data point accumulator 12 and release them to one of the model makers for retraining. Before the retraining process can occur, a model must first be generated. To do this, the ingest layer selects a data stream and designates all the data points starting from the initial time of collection of the day be directed to the 1440 data point accumulator 12. After accumulating a full collection of actual data points, the accumulator 12 releases them to the model library where they are used for training a model which is then released to the thumbnail cache for storage.

Continuing with FIG. 7, step 148 is accomplished first. In this step, the process of gathering time of collection data from a data stream and sending it from the inference engine to the thumbnail cache by bus continues. The thumbnail cache calculates the suggested data value and the region of confidence for that data point and sends it back to the inference engine. Then step 150 is accomplished which is the process of receiving the anomaly points from the inference engine and storing them at the time of collection slot in the anomaly memory 40, 42 or 44 corresponding to the time slot for the data points for the data streams in question. This process continues until a time slot rolls around on the bus 120 for the comparator process in the software. Then step 152 is accomplished wherein the comparator process in the microprocessor 104 in the software compares the number of anomaly points in, for example the memory 40, to a fixed threshold (the threshold can be user determined and user set). Step 154 then determines if the number of anomaly entries exceeds the threshold, and, if so, sets a “new model” flag on the data bit of the bus designated for same with a designation of the data stream involved. If the flag is set, the ingest layer picks that data stream for feeding to data point accumulator 12 to start collecting new data points for retraining the model in the model library 18.

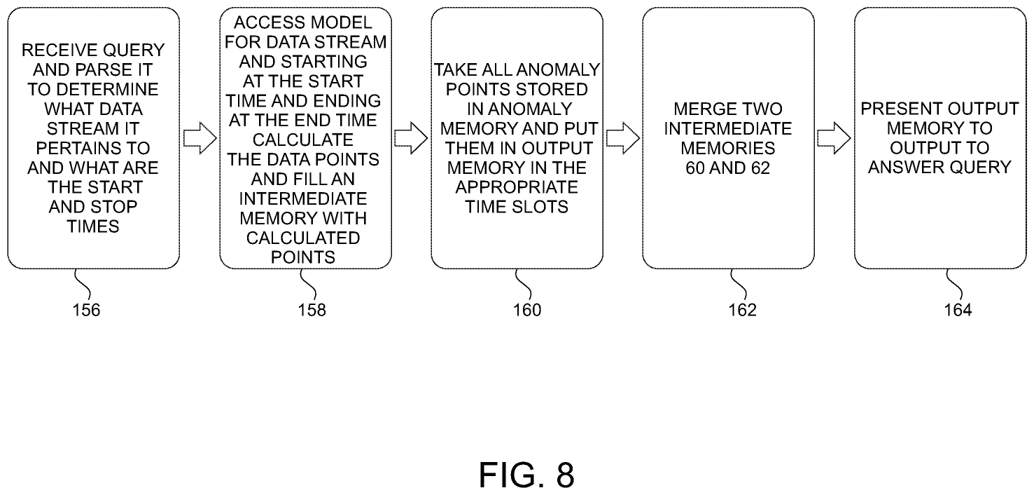

FIG. 8 is a diagram of the process of carried out in the thumbnail cache 8 of receiving a query about the data points is a data stream and answering it. In step 156 the thumbnail cache receives a query and parses it to determine what data stream s1, s2 or s3 it pertains to and what are the start times and stop times of the query. In step 158 the microprocessor 104 accesses the model for the data stream. Lets say for example it is stream s1 and the model is stored in memory segment 24. Lets say that the model is a polynomial equation. In step 158 the microprocessor 104 starts at the start time of the query and calculates the data point that would exist for that time slot in the data stream. The microprocessor 104 then fills in that time slot in an intermediate memory 60 used for the purpose of storing all the calculated points. The microprocessor 104 the moves on to the next data point following the start time and repeats the process. The microprocessor 104 repeats this process for all the data points up to and including the stop time. Next, in step 160, the microprocessor 104 accesses the anomaly memory 40 and writes all the anomaly points into their corresponding time slots in another immediate memory 62. Next, in step 162, the two intermediate memories 60 and 62 are merged into an output memory 64 so that in each time slot there is a calculated value for the data point except for the time slots where there is an anomaly. In those time slots in the output memory 64 the anomaly data points are presented. In all other time slots, the calculated value of the data point is present. Finally, in step 164 the output memory 64 is presented at the output 65 to answer the query.

Although the invention is explained with reference to a digital embodiment with a time division multiplexed bus and a microprocessor present to do the function of the inference engine and to do the function of the thumbnail cache, those skilled in the art will appreciate many variations. For example, any of the functions explained in a digital context can be done in analog circuit and even the digital circuits can be done with glue logic and not with programmed machines. All such variations are intended to be included within the scope of the claims appended hereto.

What is claimed is:

1. A process for fielding queries about a data stream that is outputting data points collected in time slots in a stream, comprising:
receiving a model of said stream in a thumbnail cache and storing it in a memory, said model capable of predicting the approximate or nominal value of data points in the data stream and a region of confidence from the time of collection of a data point;
receiving anomaly data points from an inference engine with a time of collection of each anomaly data point and storing each anomaly data point in a memory which has an address for each time slot of collection in said data stream;
receiving a query regarding said data stream having the form “give me all the data points in said data stream between time of collection t(x) and t(y)” where x and y are times of collection;
processing said query by determining the nominal data point value for each data point between times of collection t(x) and t(y) using said model and outputting all data points in an intermediate memory, and taking all said anomaly data points from said data stream and storing them in a second intermediate memory in the time slots corresponding to their collection; and
outputting an answer to said query by rewriting all nominal data points to an output memory in their time slots of calculation except for the time slots which have anomaly data points, and rewriting said anomaly data points from said second intermediate memory into the corresponding time slots in said output memory, and placing said contents of said output memory on said output line of said thumbnail cache.

2. The process of claim 1 wherein step of receiving the model in the thumbnail cache is receiving a model generated by any conventional modeling process which may be trained by the captured actual data points.

3. The process of claim 1 wherein step of receiving the model in the thumbnail cache is receiving a model generated by a prior art SARIMA model making entity where a polynomial is generated which has the coefficients are generated from captured actual data points, said polynomial being used to calculate the nominal data point from the time of capture of an actual data point in said data stream.

4. The apparatus of claim 3 wherein said SARIMA model is also capable of said region of confidence which is the highest and lowest value of said nominal data point, said region of confidence implemented by the generation of two polynomials from said captured actual data points the coefficients are trained to simulated, in one case, the highest simulated value of the data point given a time of capture, and, in a second case, the lowest simulated value of the data point given a time of capture.

5. The process of claim 1 wherein the step of receiving the model in the thumbnail cache is receiving a model generated by a prior art neural network model making entity which has nodes, the interconnection of said nodes and the coefficients of said nodes indicating when they will fire are established by training from captured actual data points.

6. The process of claim 1 wherein the step of receiving the anomaly data points from an inference engine comprises:
said inference engine receives a data point and a time of collection and the identity of the data stream from a ingest layer whose job is to receive several data streams and present each said data point to an inference engine for divining whether said data point is an anomaly of not;
said inference engine sends a query to said thumbnail cache giving the time of collection and the identity of the data stream;
said thumbnail cache determines a memory said model of said data stream is stored in and accesses said model and puts in the time of collection as the argument and calculates said nominal value of said data point and returns said nominal value of said data point and said region of confidence values to said inference engine;
said inference engine then compares the nominal value of said data point and the region of confidence values to the actual value of the data point, and decides whether said actual value is an anomaly or not;
if the actual data value is an anomaly, the value of said actual data point is reported to said thumbnail cache with the time of collection and the data stream identifier; and
said thumbnail cache accesses the memory in which said model of said data stream in stored and stores the actual value of said data point in a portion of said memory devoted to storage of said anomaly data points in the address devoted to storage of anomaly data points for said time of collection.

7. The process of claim 6 wherein a process of retraining models in a model library when the number of anomaly data points is too high, comprising:
comparing said number of anomaly data points in the anomaly memory of a model of a data stream to the number of nominal data points calculated from the time of collection data in said data stream, and determining whether the number of anomaly data points is beyond a threshold;
if the number of anomaly data points exceeds said threshold, signaling said ingest layer that it is time to designate said data stream for collection of a full set of actual data points in said data point accumulator;
when said full set of actual data points has been accumulated in said data point accumulator, releasing said full set of actual data points to said model library for retraining of said model.

8. The process of claim 1 wherein the process of receiving a model of a data stream comprises:
checking for the presence of a new model from the model library;
checking the identification of the data stream for said new model;
checking for the memory segment that said model is supposed to be stored in; and
storing said model in the dedicated memory segment.

9. An apparatus comprising:
a ingest layer means having one or more inputs for receiving a data stream from a probe collecting data points in time slots from a system being monitored, and having a first output and a second output;
a data stream selection means for generating signals to said ingest layer to control which data stream to select and put on said second output, and, when training or retraining of a model for a particular data stream is needed, for controlling said ingest layer to couple a full set of data points from said particular data stream starting with said first data point captured in said first time slot onto said first output;
a data point accumulation memory means coupled to said first output for storing a full set of data points from a designated data stream, and having an output;
an inference engine connected to said second output of said ingest layer for receiving each actual data point from each said data stream and drawing an inference whether said data point is an anomaly or not, and having an anomaly output on which anomaly data points are output, and having a data point query output at which said inference engine puts the time of capture and a data stream identifier on, and said inference engine having a calculated data point input on which said inference engine receives a nominal calculated data point value and a region of confidence value, said inference engine drawing said inference by comparing said actual captured data point value with said calculated nominal data point value and said region of confidence values;
a thumbnail model cache having one memory segment for each said data stream, each said memory segment having a segment for storing said anomaly data points in the time slots they were captured, each said memory segment of a data stream storing a model of said data stream, each said memory segment coupled to a calculation means for calculating the nominal data point and a region of confidence zone for each data point given the time of capture as an argument, said region of confidence being the high data point value and the low data point value at the time of capture, said thumbnail model cache having a query input and a query output, and having a data point query input at which said thumbnail cache receives from said inference engine a time of capture and data stream, and having a calculated data point output coupled to said calculated data point input of said inference engine, said calculation means for calculating the nominal data point and a region of confidence zone for each time of capture and data stream identifier and placing said calculated nominal data point value and said calculated region of confidence on said calculated data point output, said thumbnail model cache answering a query received at said query input in the form of “give me all the data points in time stream s(z) between time t(x) and t(y)” by invoking said calculation means and giving it the time slots t(x) through t(y) and time stream identifier s(z) to calculate all the data points comprising t(x) through t(z) and store them in a first intermediate memory and then looking up all the anomaly points stored in said memory segment for storing anomaly data points in the memory segment devoted to storing said model for time stream s(z) and storing them in a second intermediate memory in said addresses devoted to the time slots during which they were captured, and then merging said first and second intermediate memory into a final memory so all the addresses in said final memory devoted to time slots that have no anomaly stored in them have the nominal calculated value of said data point stored therein and all the addresses in said second intermediate memory that have an anomaly data point stored therein have said anomaly data point rewritten into the corresponding address devoted to the time slot in said final memory, and outputting said final memory onto said query output;
a model library having an input coupled to said output of said data point accumulation memory means, having one or more model generation means for receiving said full set of actual captured data points for a time stream and using said full set of actual captured data points to train a model for said data stream, and having an output coupled to said thumbnail model cache for outputting a completed model and a time stream designator for said model.

10. The apparatus of claim 9 wherein said ingest layer means is a one or more FIFO memories which capture data points as the arrive on said data stream(s) and store them for transmission in FIFO manner on said output coupled to said inference means on receiving a selection signal from said data stream selection means.

12. An apparatus comprising:
a ingest layer means having one or more inputs for receiving a data stream of sample data points, and having a first output and a second output;
a data stream selector coupled to said ingest layer to control which data stream to select for output at said first and second outputs;
a data point accumulation memory coupled to said first output for storing a designated data stream, and having an output;
an inference engine connected to said second output for receiving each actual data point and drawing an inference whether said data point is an anomaly or not, and having an anomaly output on which anomaly data points are output,
a thumbnail model cache having one memory segment for storing a model of said data stream or data streams where there is some relationship between data stream, each said memory segment having a segment for storing said anomaly data points from one of the data streams in the time slots they were captured, or storing the anomaly data points from one of the related data stream in the timeslot in which it was captured with an error code value,
a model library having an input coupled to said output of said data point accumulation memory means, having one or more model generation means for receiving said actual captured data points for a time stream and using said actual captured data points to train a model for said data stream, and having an output coupled to said thumbnail model cache for outputting a completed model and a time stream designator for said model.

13. The apparatus of claim 12 further comprising a query means coupled to said inference engine for answering queries about a data point given a time of capture and a time stream designator.

14. The apparatus of claim 12 having a means for answering a query received at a query input in the form of “give me all the data points in time stream s(z) between time t(x) and t(y)” comprising:
a calculation means which receives the time slots t(x) through t(y) and time stream identifier s(z) for calculate all the data points comprising t(x) through t(z) and storing them in a first intermediate memory, and then looking up all the anomaly points stored in said memory segment for time stream s(z) and storing them in a second intermediate memory in said addresses corresponding to the time slots during which they were captured, and then merging said first and second intermediate memory into a final memory and outputting said final memory.

15. The apparatus of claim 14 wherein said calculation means merges said first and second intermediate memories such that all the addresses in said final memory devoted to time slots that have no anomaly stored in them have the nominal calculated value of said data point stored therein, and all the addresses in said second intermediate memory that have an anomaly data point stored therein have said anomaly data point rewritten into the corresponding address devoted to the time slot in said final memory.
